(19) United States
(12) Patent Application Publication
(10) Pub. No.: US 2006/0288832 A1
(43) Pub. Date: Dec. 28, 2006

(54) System and apparatus for optimizing slices from slicing apparatus

(76) Inventor: Glenn Sandberg, New Lenox, IL (US)

Correspondence Address: THE LAW OFFICE OF RANDALL T. ERICKSON, P.C., 425 WEST WESLEY STREET, SUITE 1, WHEATON, IL, 60187, US

(21) Appl. No.: 11/446,614

(22) Filed: Jun. 5, 2006

Related U.S. Application Data
(62) Division of application No. 10/409,857, filed on Apr. 9, 2003, now Pat. No. 7,055,419.

(51) Int. Cl. B26D 7/06

(52) U.S. Cl. 83/75.5; 83/77; 83/107; 83/277; 83/932; 700/171

(57) ABSTRACT

A method for optimizing yield from a slicing apparatus, includes scanning and weighing a carcass, slab or loaf upstream of a slicing head of the slicing apparatus. The carcass, slab or loaf weight is divided by a desired pre-selected portion weight to determine the number of slices to be made. A remainder portion is allocated to an intermediate position along the carcass, slab or loaf to be sliced from the carcass, slab or loaf before a butt end portion, gripped by a gripper of the slicing apparatus, reaches the slicing head. The butt end portion is pre-arranged to be the desired pre-selected portion weight or at least an acceptable pre-selected portion weight. The butt end portion can then be released by the gripper as a desired or acceptable weight portion.

The application claims the benefit of provisional application Ser. No. 60/439,157 filed Jan. 10, 2003.

This Application is a Divisional Application of U.S. Ser. No. 10/409,857 which was filed on Apr. 9, 2003.

### TECHNICAL FIELD OF THE INVENTION

The invention relates to slicing systems for food products such as cheese, meat and pressed or molded meat products. The invention particulary relates to a slicing system that divides slabs or meat carcasses such as bacon bellies.

### BACKGROUND OF THE INVENTION

It is known in Germany to divide bacon bellies into smaller portions or chunks for sale to a customer. The customer can then further slice or otherwise process these portions.

Referring to FIG. 1, according to a typical system, bacon bellies are fed through a slicing apparatus 6 while being gripped by a gripper 30 on the end farthest from the slicing blade 34, the “butt end” of the belly. The bellies are divided at increments to make acceptable slices or portions 10, 12, 14, 16, 18, 20 of desired target weights, such as 300 or 350 grams, until the butt end piece 22 is too short to sever a piece being of the desired target weight. It is possible that the butt end piece is heavier than the desired target weight but a forward length of the butt end piece cannot be severed due to the presence of the gripper. In practice, the rearmost portion 22a of the butt end piece 22, having a length 22b is engaged by the gripper and corresponds to about 140 grams of the butt end piece. Thus, the butt end piece can in fact be greater than say 300 grams but a 300 gram piece cannot be severed due to the presence of the gripper 30, i.e., the gripper 30 would interfere with the cutting blade 34. For example, a butt end piece could be 340 grams. Given an acceptable 300 gram slice, the rearmost 40 grams is insufficient to be engaged by the gripper during slicing off of the 300 gram slice. The entire butt end piece 22 (340 grams) is typically then redirected to a processing station where it is manually trimmed to 300 grams and reused as an acceptable slice with the remaining portion reprocessed or discarded. If the butt end piece is less than 300 grams it is reprocessed or discarded.

The present inventor has recognized the desirability of eliminating unnecessary manual steps and the desirability of optimizing the automatic sliced product output.

### SUMMARY OF THE INVENTION

The present invention provides a method and apparatus for optimizing the sliced product from a carcass, slab or loaf.

According to the preferred embodiments of the invention, a carcass, slab or loaf is scanned and weighed upstream of the slicing apparatus. The carcass, slab or loaf weight is divided by a desired pre-selected portion weight to determine the number of slices to be made. A remainder portion is allocated to an intermediate position along the carcass, slab or loaf to be sliced from the carcass, slab or loaf before a butt end portion reaches the slicing head. The butt end portion is pre-arranged to be the desired pre-selected portion weight or at least an acceptable pre-selected portion weight.

The carcass, slab or loaf is sliced at incremental positions as the carcass, slab or loaf is advanced through the slicing apparatus to produce acceptable slices that are conveyed from the slicing apparatus. The remainder portion is sliced and removed from the carcass, slab or loaf before the butt end portion reaches the slicing blade. The remainder portion is removed for recycling or is discarded. After the remainder portion is removed, the butt end portion is released by the gripper and conveyed as an acceptable slice with the preceding acceptable slices.

By removing the remainder portion using the slicing head of the slicing apparatus and conveying the released butt end portion as a pre-determined acceptable slice, the step of manually removing the remainder portion from a butt end portion is eliminated.

As a further refinement of the invention, two or more pre-selected different slice weights can be removed from the carcass, slab or loaf and then classified downstream of the slicing apparatus. In this case, the number of slices of each weight taken from the carcass, slab or loaf can be optimized to use as much of the carcass, slab or loaf as possible, minimizing the remainder portion. The remainder portion is preferably removed before the butt end portion reaches the slicing blade, the butt end portion being pre-calculated to be equal to one of the two different slice weights.

Numerous other advantages and features of the present invention will be become readily apparent from the following detailed description of the invention and the embodiments thereof, the claims, and from the accompanying drawings.

### BRIEF DESCRIPTION OF THE DRAWINGS

FIG. 1 is a schematic diagram of a carcass, slab or loaf in a slicing apparatus showing the location of cut lines according to the prior art;

FIG. 2 is a schematic diagram of a carcass, slab or loaf in a slicing apparatus showing the location of cut lines according to the invention;

FIG. 3 is a schematic diagram of a carcass, slab or loaf in a slicing apparatus showing the location of alternate cut lines according to the invention; and

FIG. 4 is a schematic diagram of an overall system for optimizing slices according to the invention.

### DETAILED DESCRIPTION OF THE PREFERRED EMBODIMENTS

While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

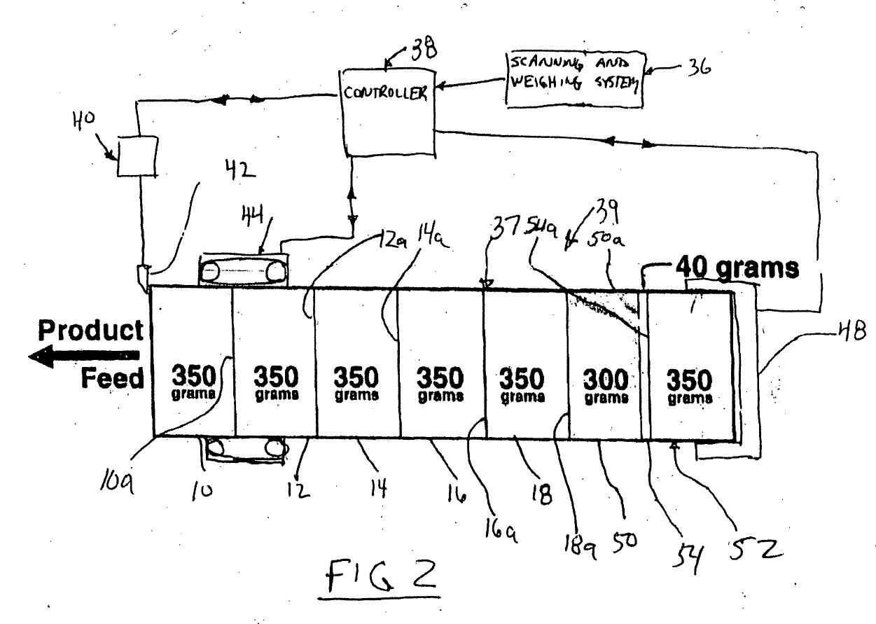

FIG. 2 demonstrates a first embodiment according to the invention wherein a typical 2440 gram bacon belly slab 37 is to be divided. A first target weight can be 350 grams and a second target weight can be 300 grams. Either target weight is an acceptable amount for packaging and sale. The slab 37 is shown located in a slicing apparatus 39.

A scanning and weighing system 36 weighs and profiles the slab 37 to be divided, before the slab is placed in the apparatus 39. The scanning and weighing system 36 can be an apparatus as disclosed in PCT/US00/10691 filed Apr. 20, 2000 or U.S. Ser. No. 09/959,876, flied Oct. 22, 2001, herein incorporated by reference and/or as sold commercially as a FORMAX SNS system manufactured by Formax, Inc. of Mokena, Ill., USA. The scanning and weighing system 36 is signal-connected to a controller 38. The controller 38 is signal-connected to a slicing blade drive 40 that controls a slicing blade 42, a conveyor drive system 44 and a gripper and drive system 48. The controller 38 determines each slice thickness according to the weight and profile of the slab, and adjusts the drives 40, 44, 48 to locate intermittent cut lines 10a, 12a, 14a, 16a, 18a, 50a and 54a. The slicing machine, including slice thickness control, can be of the type as described in U.S. Pat. Nos. 5,628,237; 5,649,463; 5,704,265; and 5,974,925; as well as patent publications EP0713753 and WO99/08844, herein incorporated by reference. The slicing machines can also be commercially available FORMAX FX180 and FORMAX SNS machines, available from Formax, Inc. of Mokena, Ill., U.S.A.

The controller 38 pre-calculates the optimal number of target weight slices to be cut from the slab 37 given a first preference for the first target weight and a second preference for the second target weight. According to the embodiment, a last slice having one of the pre-selected target weights is the butt end portion 52.

According to the illustrated embodiment, six portions 10, 12, 14, 16, 18, 52 have the first target weight of 350 grams, and one portion 50 has the second target weight of 300 grams. A remainder portion 54, in the illustrated example a 40 gram slice, is located before the butt end portion 52 and can be sliced and removed by the slicing blade 42.

The number of slices having the first target weight and the number of slices having the second target weight can be mathematically determined by the controller 38 given the weight and profile of the slab 37 to optimize the number of acceptable slices and to minimize the remainder portion 54.

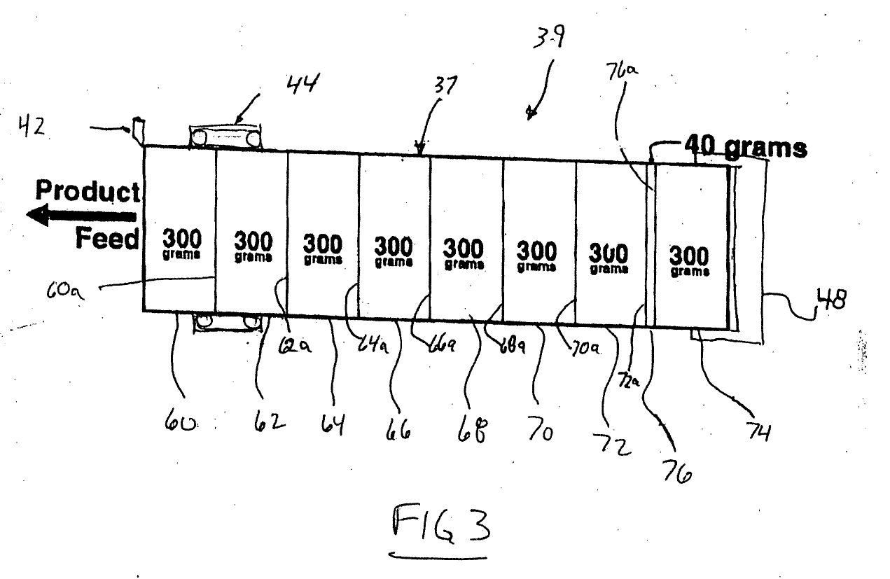

FIG. 3 illustrates another embodiment wherein a 300 gram first preference target weight is used for the 2440 gram slab 37. According to this embodiment, 300 gram portions 60, 62, 64, 66, 68, 70, 72 and 74 can be sliced with a 40 gram remainder portion 76 to be recycled or discarded.

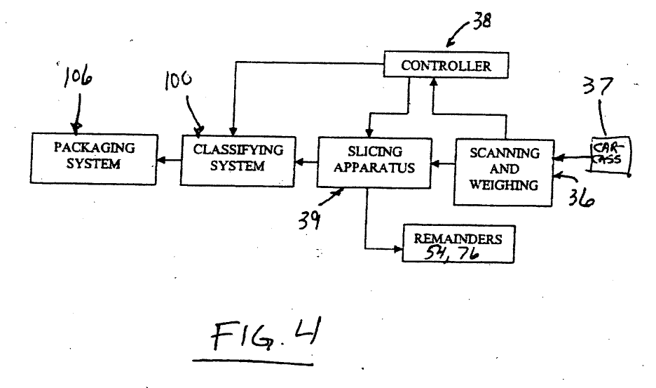

FIG. 4 illustrates the overall system in block diagram form. The carcass, slab or loaf 37 is first scanned and weighed by the scanning and weighing system 36. The scanning and weighing system 36 sends carcass, slab or loaf profile and weight information to the slicing controller 38 which controls the slicing apparatus accordingly to slice the carcass, slab or loaf 37. The slicing apparatus discharges the remainder portions 54, 76 via an offload conveyor or a bucket. The acceptable slices, including the butt end portions 52, 74 are conveyed to a classifying system 100 such as described in U.S. Pat. No. 5,499,719 or of the type as described in U.S. Pat. Nos. 5,628,237; 5,649,463; 5,704,265; and 5,974,925; as well as patent publication EP0713753, herein incorporated by reference. The classifier can also be provided with the commercially available FORMAX FX180 and FORMAX SNS machines, available from Formax, Inc. of Mokena, Ill., U.S.A. Slices of different target weights, say 300 or 350, are classified, such as directed to different conveyers, accordingly. The slices are then conveyed to one or more packaging systems 106.

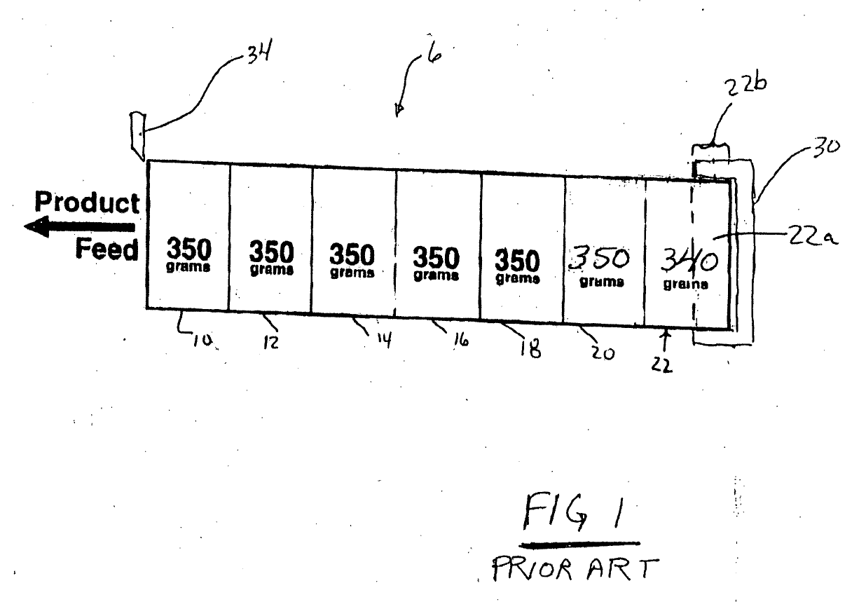

Using the two examples of FIG. 2 and FIG. 3 and comparing these examples to the typical prior art example of FIG. 1, an improved machine yield is demonstrated, the “machine yield” being defined as the aggregate weight of the acceptable slices delivered through the slicing apparatus divided by the total carcass, slab or loaf weight into the slicing apparatus.

FIG. 1: 2100 grams/2440 grams=86%

FIGS. 2 and 3: 2400 grams/2440 grams=98%

From the foregoing, it will be observed that numerous variations and modifications may be effected without departing from the spirit and scope of the invention. It is to be understood that no limitation with respect to the specific apparatus illustrated herein is intended or should be inferred.

The invention claimed is:

1. (canceled)

2. (canceled)

3. (canceled)

4. (canceled)

5. (canceled)

6. (canceled)

7. (canceled)

8. A system for optimizing yield of slices from a carcass, slab or loaf comprising:
a slicing blade defining a slicing plane;
a gripper for gripping a back end of a carcass, slab or loaf;
a drive for driving a lead end of the carcass, slab or loaf into the slicing plane;
a weighing and scanning apparatus that determines a weight distribution profile along the carcass, slab or loaf;
a control that is configured to pre-calculate position of cuts along the carcass, slab or loaf to maximize the number of acceptable portions defined as having at least one pre-selected target weight and a remainder portion, wherein a last portion held by the gripper is pre-arranged to be an acceptable portion, said control controlling said drive for positioning said cuts along the carcass, slab or loaf.

9. The system according to claim 8, further comprising:
a classifying conveyor, said classifying conveyor configured for segregating said acceptable portions of said first target weight together and said acceptable portions of said second target weight together and said remainder portion together from the division of successive carcasses, slabs or loaves.

10. A system for optimizing yield of slices from a carcass, slab or loaf comprising:
a slicing blade defining a slicing plane;
a gripper for gripping a back end of a carcass, slab or loaf;
a drive for driving a lead end of the carcass, slab or loaf into the slicing plane;
a weight profiling apparatus that determines a weight distribution profile along the carcass, slab or loaf;
a control that is configured to pre-calculate position of cuts along the slab to maximize the number of acceptable portions defined as having at least one pre-selected target weight and a remainder portion, wherein a last portion held by the gripper is pre-arranged to be an acceptable portion, said control controlling said drive for positioning said cuts along the carcass, slab or loaf.

11. The system according to claim 10, further comprising:
a classifying conveyor, said classifying conveyor configured for segregating said acceptable portions of said first target weight together and said acceptable portions of said second target weight together and said remainder portion together from the division of successive carcasses, slabs or loaves.

12. The system according to claim 10 wherein said carcass, slab or loaf is gripped by said gripper only upstream of said slicing blade.

13. The system according to claim 12, wherein said control pre-arranges said remainder portion to be adjacent to said last portion.

14. The system according to claim 13, wherein said control pre-calculates positions of cuts according to two target weights: a first target weight, and a lesser, second target weight.

15. The system according to claim 14, wherein said control pre-calculates positions of cuts such that the number of acceptable portions of the first target weight is maximized for each carcass, slab or loaf.

16. The system according to claim 14, wherein said control pre-calculates positions of cuts such that the number of first target weight acceptable portions and the number of second target weight acceptable portions are optimized to result in a remainder portion of minimum weight.

17. The system according to claim 16, wherein said profiling apparatus comprises a weigh scale and a scanning apparatus, wherein each carcass, slab or loaf is weighed by the weigh scale and scanned by the scanning apparatus to determine a weight distribution profile along the carcass, slab or loaf before the control pre-calculates position of cuts.
